(19) United States
(12) Patent Application Publication
(10) Pub. No.: US 2009/0313570 A1
(43) Pub. Date: Dec. 17, 2009

(54) SYSTEM AND METHOD FOR INTEGRATING LOCATIONAL AWARENESS INTO A SUBJECT ORIENTED WORKFLOW

(76) Inventor: Ronald T. PO, Pasadena, CA (US)

Correspondence Address: DALINA LAW GROUP, P.C., 7910 IVANHOE AVE. #325, LA JOLLA, CA, 92037, US

(21) Appl. No.: 12/139,423

(22) Filed: Jun. 13, 2008

(51) Int. Cl. G06F 3/048

(52) U.S. Cl. 715/772

(57) ABSTRACT

One or more embodiments of the invention are directed to a system and method for integrating locational awareness into a subject oriented workflow system that functions within the context of a professional services environment. The system described herein may be implemented in a general purpose computer system that is configured to handle various subject contexts within the confines of a graphical user interface. The term subject as it is used here relates to the person that a professional service is being provided on or in conjunction with. For instance, in a clinical setting the subject might be a patient and the professional service provider a doctor or other medical professional. In a lawyer/client context the subject would refer to the client and the professional service provider to the lawyer or support staff.

### BACKGROUND OF THE INVENTION

1. Field of the Invention

One or more embodiments of the invention described herein pertain to the field of computer systems. More particularly, but not by way of limitation, one or more embodiments of the invention enable a system and method for integrating locational awareness into a subject-oriented workflow system.

2. Description of the Related Art

The modern workplace is complex. As the amount of information workers must navigate increases so does the need for systems that are able to assist in managing the sheer quantity of information encountered on the average business day. System developers, seeking to achieve better management of information and keep workers in constant communication with one another, have developed various collaboration and workflow systems. The purpose of such systems is to increase communication and organize data in such a way that it becomes associated with defined tasks that are performed by an assigned person on a given timeline. A well-defined workflow system is able to make sure that the right people bring the right work into play in the right sequence and at the right time for action. Such a system enables workers to accomplish the tasks that need to be done when they need to be done, while reducing the number of errors committed and the time and effort spent managing the tasks.

While there are numerous existing workflow applications these existing applications are generally catered to creating a prioritized list of tasks that are organized along a timeline. One of the major limitations these existing workflow systems have is that the systems are centered around tasks being presented to the responsible person in a way that is not locationally and contextually aware in regards to which tasks are appropriate to perform depending on the location and context of the responsible person and/or the location and context of the subject being acted upon. These limitations become particularly apparent when trying to implement a workflow system in a professional services environment where the tasks are driven more by being locationally proximate to a person or thing than according to a timeline.

In the context of a hospital, for instance where doctors and medical personnel identify actions to be taken and follow-up actions based on their professional judgment, workflow systems are generally unable to assist in identifying the series of tasks that must occur for each patient. Instead such systems are generally configured to simply store and retrieve patient records and are not integrated in any capacity into a dynamic workflow where actions are triggered based on the context and particular needs of the patient. The problems with using workflow systems in hospitals becomes more complex in an arena such as an occupational health clinic where the professional services that are provided to the patient are driven by the requirements of an employer of the patient as well as the judgments of a professional healthcare provider. For instance, existing systems lack a mechanism for cohesively combining employer or insurance protocol instructions with subjects in a system that can then be integrated into a workflow that enables integrated patient evaluation, treatment, billing and accounting through a single interface.

For at least the reasons set forth above there is a need for a workflow management system that integrates locational awareness into a subject oriented workflow system.

### BRIEF SUMMARY OF THE INVENTION

One or more embodiments of the invention are directed to a system and method for integrating locational awareness into a subject oriented workflow system that functions within the context of a professional services environment. The system described herein may be implemented in a general purpose computer system that is configured to handle various subject contexts within the confines of a graphical user interface. The term subject as it is used here relates to the person that a professional service is being provided on or in conjunction with. For instance, in a clinical setting the subject might be a patient and the professional service provider a doctor or other medical professional. In a lawyer/client context the subject would refer to the client and the professional service provider to the lawyer or support staff.

To implement one or more embodiments of the invention the general-purpose computer system is configured to present an intake interface to intake personnel on receipt of an indication that a subject desires services rendered in a professional services environment. Intake personnel are generally those who are responsible for subject sign in or registration when the subject arrives at the location where the professional service is to be provided. In one case for instance, the subjects are patients of an occupational health clinic. Using this intake interface identifying information about the subject is obtained and stored for subsequent processing in conjunction with an employer of the subject. Once the employer-related details are defined or retrieved the system obtains these details to determine what professional services are to be rendered on the subject. Hence the system associates the subject with at least one employer-defined action using the employer-related details on file. This action to be taken by the professional is then stored in the computer system for presentation to a professional who is to render the professional service.

Having associated the action(s) to be taken by the professional on the subject the system presents a graphical user interface comprising a list of at least one graphical representation of subjects having associated actions scheduled for professional services within a defined timeframe. This interface enables both the professional and personnel to determine at a glance how many subjects are in need of the professional's service. The system also contains interface components that visually represent the professionals available to render the needed actions on the subjects.

An intake status, for example the registration, sign in of a subject, etc., is then indicated for the subject by moving the graphical component representative of the subject to a screen region that associates the intake status with the subject. This enables users of the system to determine at a glance how many patients are signed in. On sign-in a time is associated with each subject so that the amount of time between sign-in and sign-out can be monitored and reported. Now having a sign-in time the subject is assigned a waiting status and the interface is updated to reflect this status by moving the graphical component that represents the subject into a screen region that indicates the subject has a waiting status. The waiting region of the interface shows how many subjects are awaiting the defined action by one of the professional services providers.

The system is configured to release the subject from a waiting status to an in room status when the graphical component representative of the subject is moved to a screen region indicating the subject is in a room where the professional is to provide the designated action. Subjects are associated with an assigned professional using this interface thereby enabling the professional to determine at a glance which subject next requires attention and what actions or services a particular subject requires. The subject's file (e.g., patient record or matter file) is accessible to the professional in room and the next actions or details about the professional's performing the defined action may be entered electronically against that record. Different professionals may be associated with the subject and/or the subject may be shown to be moving in and out of various rooms by moving the graphical components that represent either the subject or professional as needed.

Once the professional has completed the defined actions as well as any additional actions deemed necessary through professional judgment the subject may be given a sign-out status by moving the graphic to the sign-out region of the interface. On sign-out the system sets a sign-out status and triggers production of any documents that accompany the professional services. Billing or partial billing may occur with a task being added to a queue for billing personnel.

### BRIEF DESCRIPTION OF THE DRAWINGS

The above and other aspects, features and advantages of the invention will be more apparent from the following more particular description thereof, presented in conjunction with the following drawings wherein:

FIG. 1 shows a workflow overview screen, on which an at-a-glance workflow view is shown and can be edited by direct manipulation of the items on screen.

FIG. 2 shows a details screen relating to a subject that could be new to the system, about to enter the workflow, currently in the workflow, or a person who has exited the workflow and is waiting to re-enter.

FIG. 2A shows an embodiment of the details shown in screen of FIG. 2 comprising further details related to the subject.

FIG. 2B shows an embodiment of the details shown in screen of FIG. 2 comprising further details related to the subject.

FIG. 2C shows an embodiment of the details shown in screen of FIG. 2 comprising further details related to the subject.

FIG. 2D shows an embodiment of the details shown in screen of FIG. 2 comprising further details related to the subject with a container for digital media.

FIGS. 3 and 3E show a schedule view in which subjects are scheduled for professional services to enter the workflow at a particular time and date.

FIGS. 3A through 3D show sub-screens of the schedule view of FIG. 3.

FIG. 4 shows a method of entering, monitoring and moving a subject through a real time workflow system.

FIGS. 5A and 5B show comparisons of subject details screens to illustrate the multi-record per subject capability of the system.

### DETAILED DESCRIPTION

A system and method for integrating locational awareness into a subject-oriented workflow system that functions within the context of a professional services environment will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, well known to those of ordinary skill in the art have not been described in detail so as not to obscure the invention. Readers should note that although examples of the invention are set forth herein, the claims, and the full scope of any equivalents, are what defines the invention.

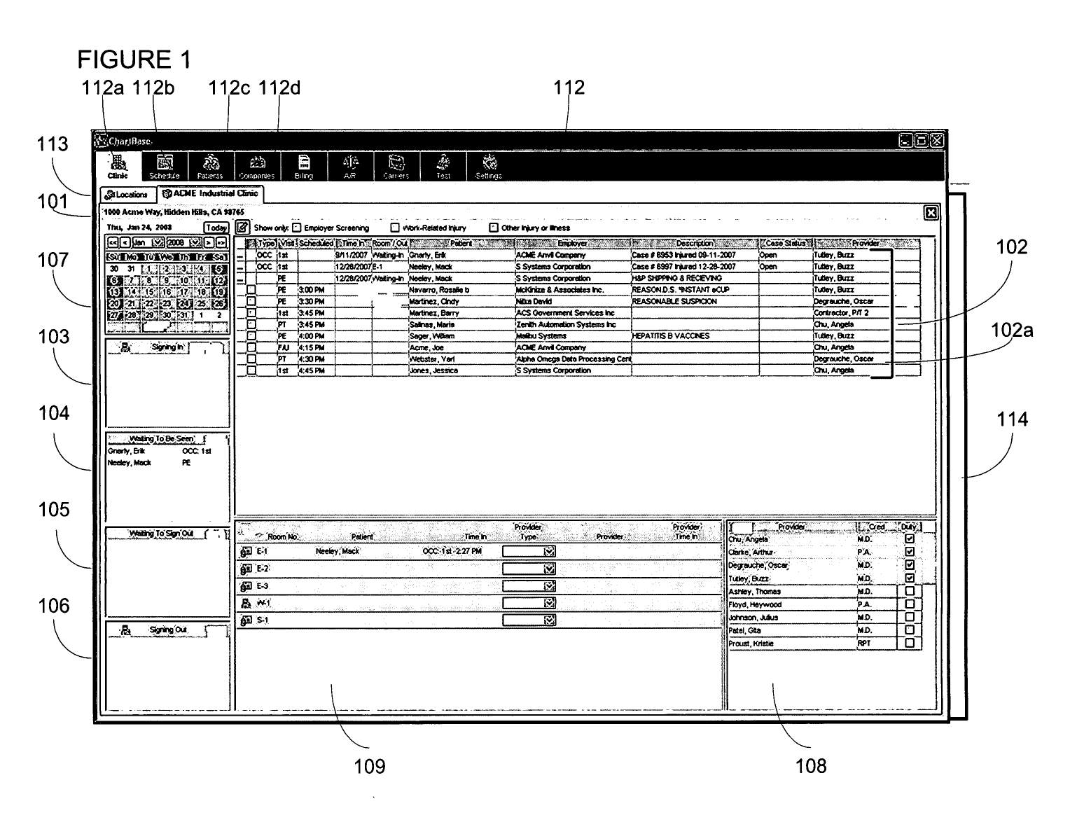

FIG. 1 shows a graphical user interface used in the integration of locational awareness into a subject oriented workflow system. The interface is comprised of screen regions for user interaction. A screen region functioning as a category selection interface provides a listing of available categories. In this example, the top of the screen region at 112 is displayed in the form of a horizontal, thin rectangle operating and functions as the category selection interface. Category selection interface 112 comprises further screen regions which graphically represent various categories of the workflow and software which upon activation alter the rest of the screen regions, collectively shown at 114, to correspond to the selected category. In the example shown 112a, 112b, 112c and 112d are all graphical representations of interface functions, in this instance 112a represents “Clinics,” 112b represents “Schedule,” 112c represents “Patients,” and 112d represents “Companies.” Other categories can also be represented within this category selection screen region. The category selection interface 112 is in this embodiment common to all figures and areas of the interface described. FIG. 1 in the example has selected from this region “Clinic,” at 112a which indicates that the rest of the screen regions 114 correspond to the “Clinic” function of the workflow. Directly beneath the main category selection region 112 is screen region 113 comprising rectangular tabs that on selection alter parts of screen region 114 to display pertinent information. In the example embodiment shown, the rectangular tabs of 113 represent clinics for selection, the workflow of each is represented below in further screen regions. Beneath screen region 113, along the left hand side of the interface are vertically arranged rectangular screen regions 103-107. In the examples provided, five screen regions are shown to represent the various states of the workflow, however any number of vertically arranged screen regions may be implemented depending on the workflow being represented. The uppermost of these screen regions in this example at 107 comprises a set of screen regions for the selection of dates in a calendar styled entry form. Beneath these screen regions 103, 104, 105 and 106 which indicate the status of subjects congruent with the subject oriented workflow. These are described in further detail below. To the right of these screen regions is a large rectangular screen region 102. Screen region 102 covers the top half of the remaining area at 114, and comprises a list of subjects within the subject oriented workflow. The list comprises sets of columns for each entry, where the entries are populated by the selection of a date from 107. The columns have titles containing metadata relating to the data beneath. The columns provide different information relating to the subject. In this example, a typical entry includes a graphic status indicator on the left hand side, a type of visit, a text description of the current status, and demographic information relating to the subject, such as the subject name and so on. This information varies depending on the situation in which the work flow is operating. Directly above screen region 102 are screen regions that may be used to filter the information shown in screen region 102. Beneath screen region 102 are two horizontally arranged screen regions 109 and 108. Screen region 109 consists of further screen regions in the form of a list that in this example are representative of further locations within the subject oriented workflow. This list also contains columns and metadata titles for each column. Screen region 108 next to this screen region comprises a further list, wherein this example the information comprises doctors. Each entry within this list has a rectangular check box on the far right side of the entry which may be selected by a user of the interface to indicate the status of that entry. This status data, much like the data entries populated in screen region 102, is varied based on the date selected in screen region 107.

In the example depicted here in FIG. 1 category selection screen region 112 further defines a number of content interfaces each of which have a sub-level of detail. When selected a “clinic” category within category screen region 112 opens a sub-level interface providing screen elements for retrieving or detailing clinic information. When selected a “schedule” category within category screen region 112 opens an interface for retrieving or detailing scheduling-related information. A “patient” category within category screen region 112 opens an interface for retrieving or detailing patient related information. A “companies” category within category screen region 112 opens an interface for retrieving or detailing company-related details. A “billing” category within category screen region 112 opens an interface for retrieving or detailing billing-related information. An “Accounts Receivable” category within category screen region 112 opens an interface for retrieving or detailing information related to amounts due from professional services rendered or costs related thereto. A “carriers” category within category screen region 112 opens an interface for retrieving or detailing information about insurance carriers. A setting category provides users with an ability to adapt the system to their specific needs. The categories comprising screen region 112 may vary depending on the permission level of the system user, and also on the embodiment of the workflow, allowing for the customized setting and arrangement of categories as is appropriate to the embodiment.

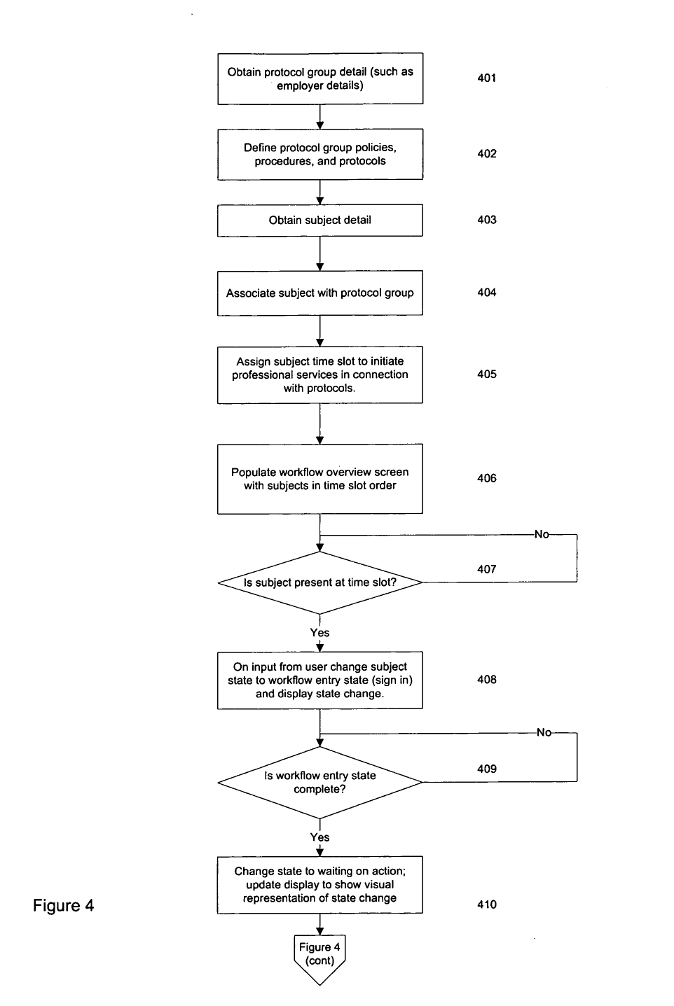

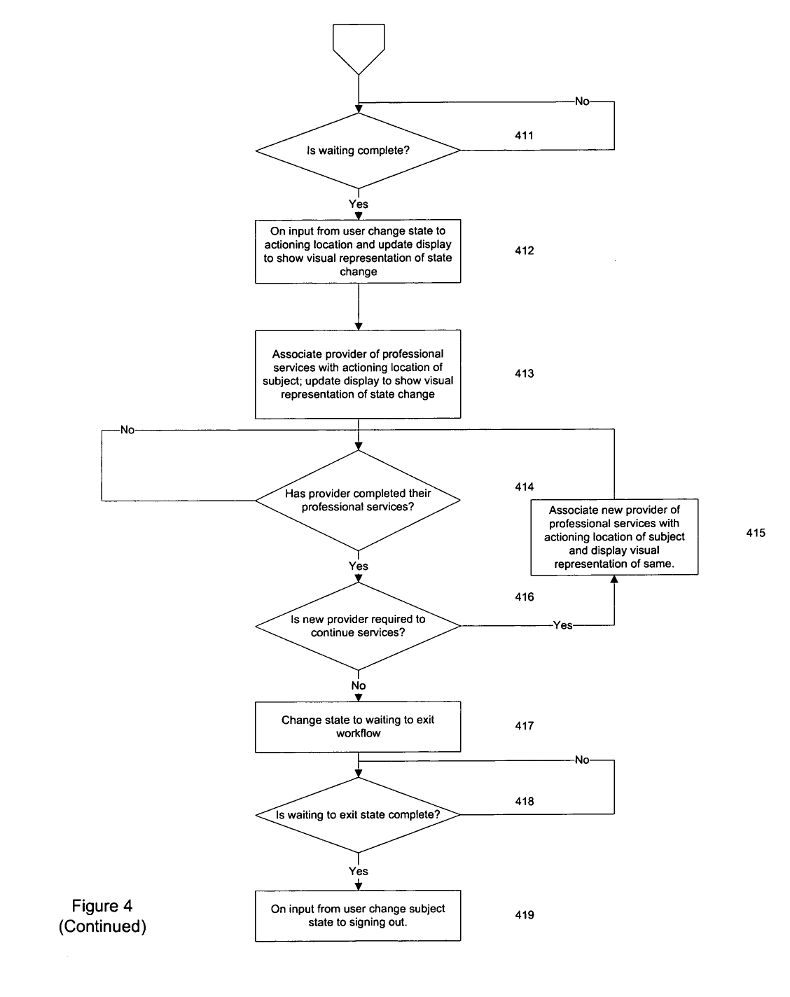

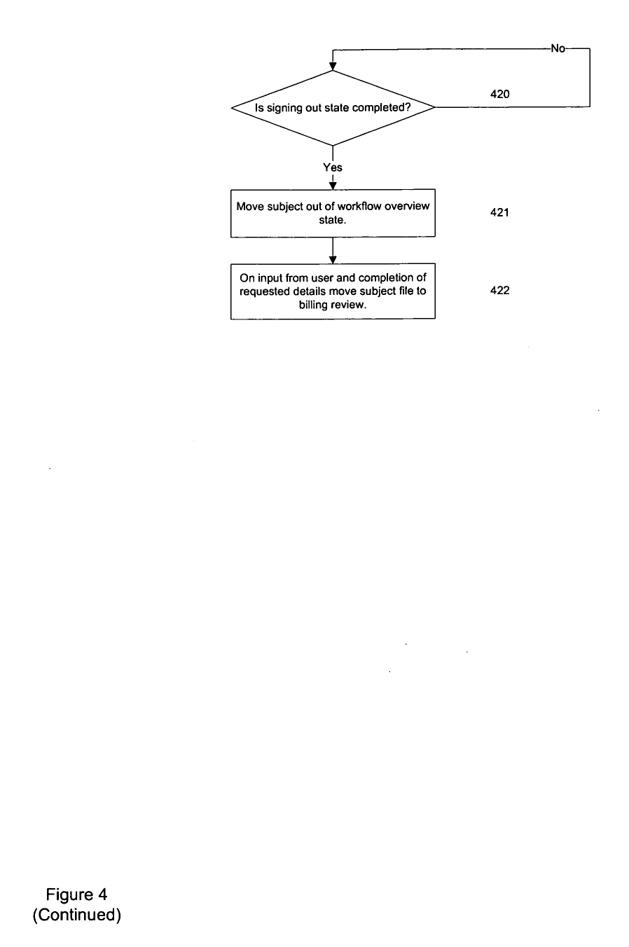

FIGS. 1 and 4 will now be described in tandem; with FIG. 4 describing and illustrating a method of the invention, and FIG. 1 showing an embodiment of the method in the context of a graphical user interface. It will be apparent to the reader that FIG. 1 is intended to show the method in action, however any iteration or variant thereof is contemplated as being within the scope and spirit of the invention. FIG. 1 shows as described above, a graphical user interface comprising a list graphical components representative of subjects who are in need of actions by a professional. The subjects represented by these graphical components are patients, clients or other recipients of a professional service. The subjects on this list are generally those where an action such as the professional service is scheduled within a defined timeframe (e.g., 101). The user interface of FIG. 1 comprises a plurality of screen regions arranged in a single interface that are used to designate positions and statuses within a locational based workflow, both of the subjects and the persons providing professional services. By viewing and using this interface a user, or any person viewing and using the interface, can see at a glance the status of subjects in the workflow at any given point in time.

The term user as it is specified throughout is considered to be a person operating the system described in whatever position relevant to the embodiment used, however readers should note this user could also be an automated process or a group of users depending on the used embodiment of the invention. A subject is any person, document, item or piece of information that requires attention in such a manner that it can be tracked and updated through the invention provided. In the example described herein without reference to the claims the subject is a patient with associated demographic information, cases and medical history. However any type of person, such as a customer, or client, or any other object, such as a document, folder, case, could be a subject depending on the embodiment of the invention implemented. The professional services are particular actions that are undertaken by any form of professional, such as in this example a doctor or nurse performing medical actions on a patient, whereas a provider is considered to be a person administering said actions.

FIG. 4 shows a high level method for entering and tracking subjects and their associated actions and cases in a real time format. It is understood that in the context of the invention, real time is taken to mean a system that is capable of refreshing data from a data source in a period of time where users do not generally notice delay from the system in processing tasks. For the purposes of example, in this figure a list of patients in a hospital with appointments is shown at 102. Readers should note however that the invention is not limited to such a context and may be adapted for use with any list of persons or objects needing services rendered by a professional. Screen region list 102 is populated by selecting a specific date from screen region 107 and pulling records from the database where actions are to be carried out on the specified date (see e.g., steps 405 and 406). The subject's position within a workflow is then shown both in the list at 102a and in screen regions located around timeframe 101. Upon the arrival of a subject scheduled to enter the workflow (see e.g., step 407), the subject is assigned an entry status by moving the subject from list 102 to entry screen region 103 as represented in the method at 408.

In the FIG. 4 example embodiment, upon entry to the hospital a graphical representation of the patient on the user interface is moved to the “Signing In” screen region. Once moved the system associates an intake status, such as a starting or sign-in status, with the patient indicating it is time to render the professional services through subsequent events. The intake status is generally triggered by the physical presence or location of the subject but is not limited to such as starting may also represent any status that represents an entry point to a workflow. Hence the starting status covers actions such as the arrival of a subject, sign-in of the subject, enrollment in a service, request for service or other actions where a subject is to be provided a professional service under terms defined by the subject or an entity associated with the subject such as an employer.

For purposes of example this intake status is described in the context of a sign-in status given to a subject such as a patient arriving for treatment by a professional. Other starting scenarios for triggering the workflow are also plausible. Upon entry of a person into the sign-in region of the graphical user interface a subject screen with details of the appointment listed in 102 is presented to the end user. The subject screen defines various details that are related to the appointment for which the subject has arrived. Basic demographic information about the subject such as the subject's name, address information, telephone numbers and insurance information is detailed along with digital copies of relevant identifying documents (e.g., drivers' license, health insurance cards, etc.). Case information providing details of the subject's past and/or future appointments is also presented or accessible via the subject screen. Information about whether the appointment is pending, completed or requires follow-up is provided. Case details providing information about the reasons for the subject's previous visits and what professional services were rendered is stored in the system and accessible via the subject screen or through other interfaces.

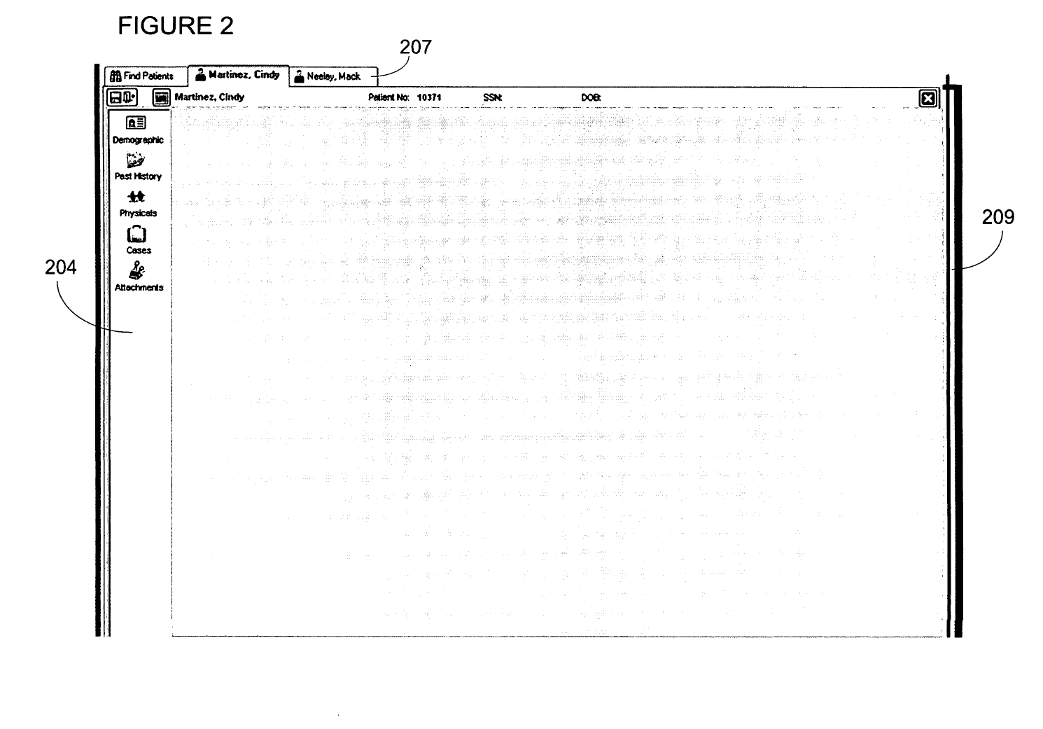

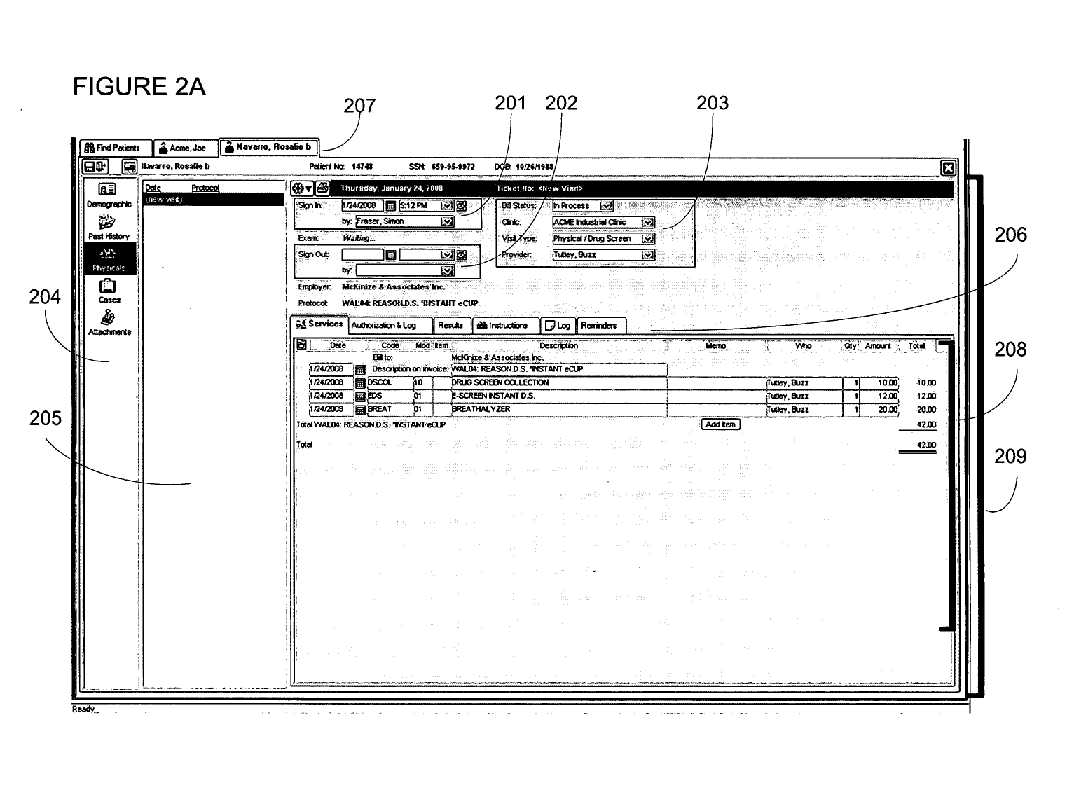

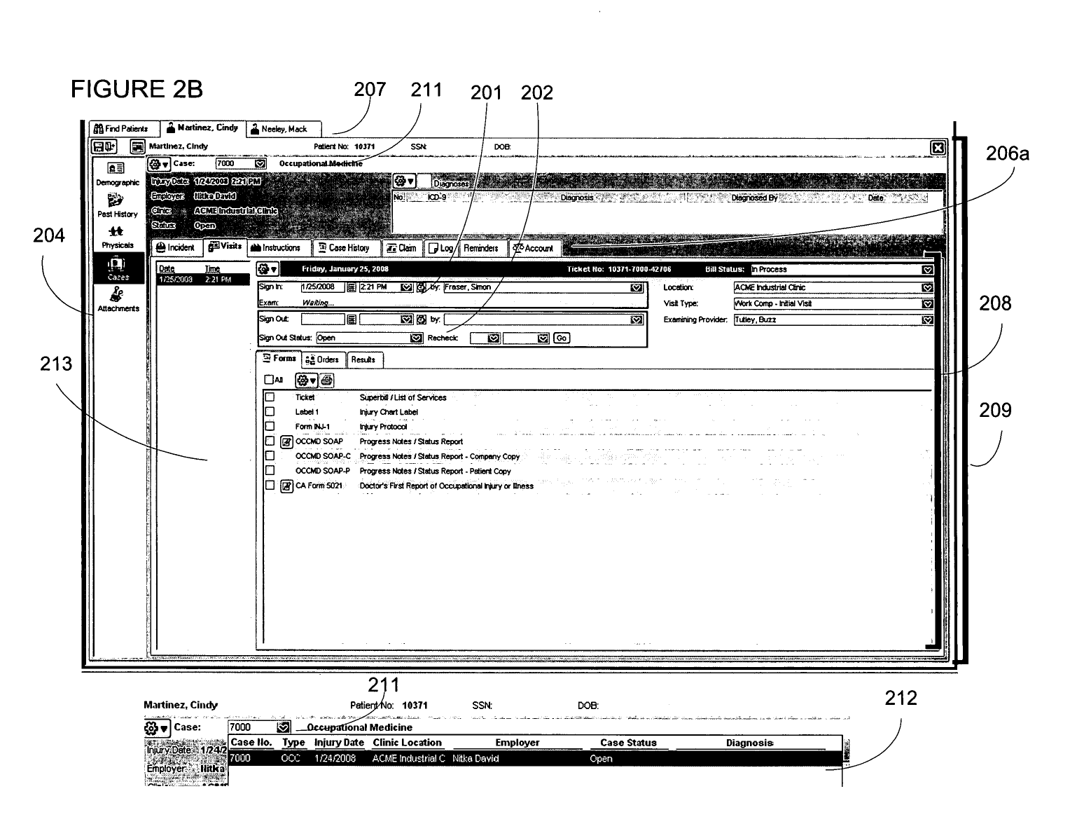

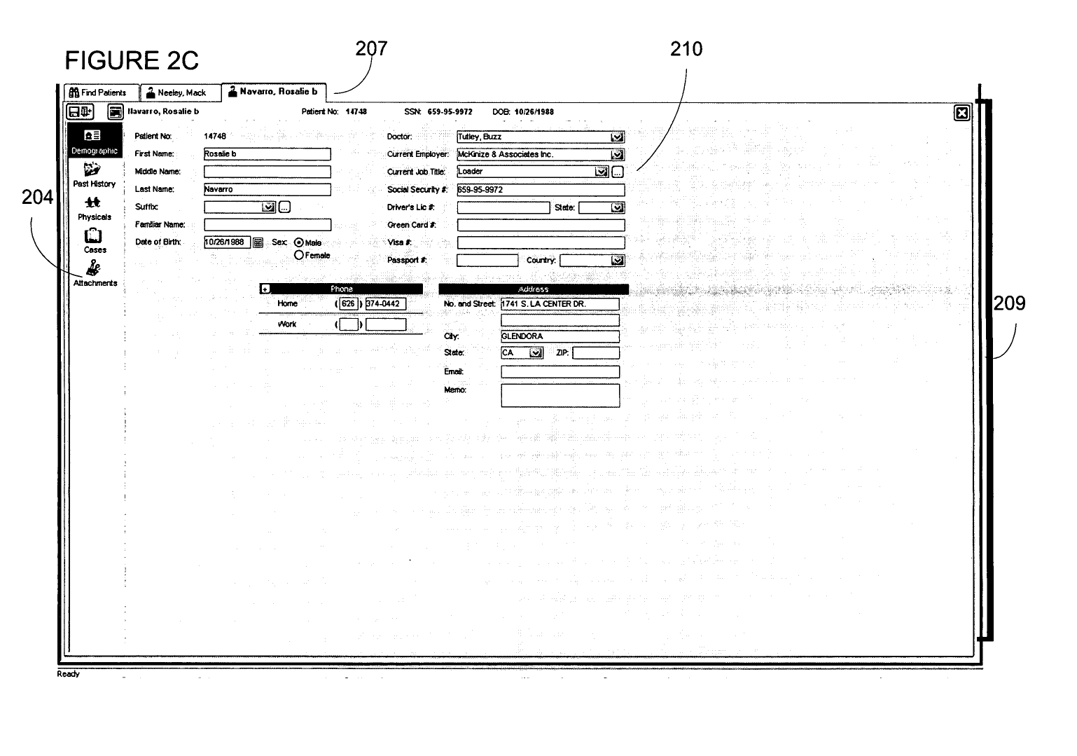

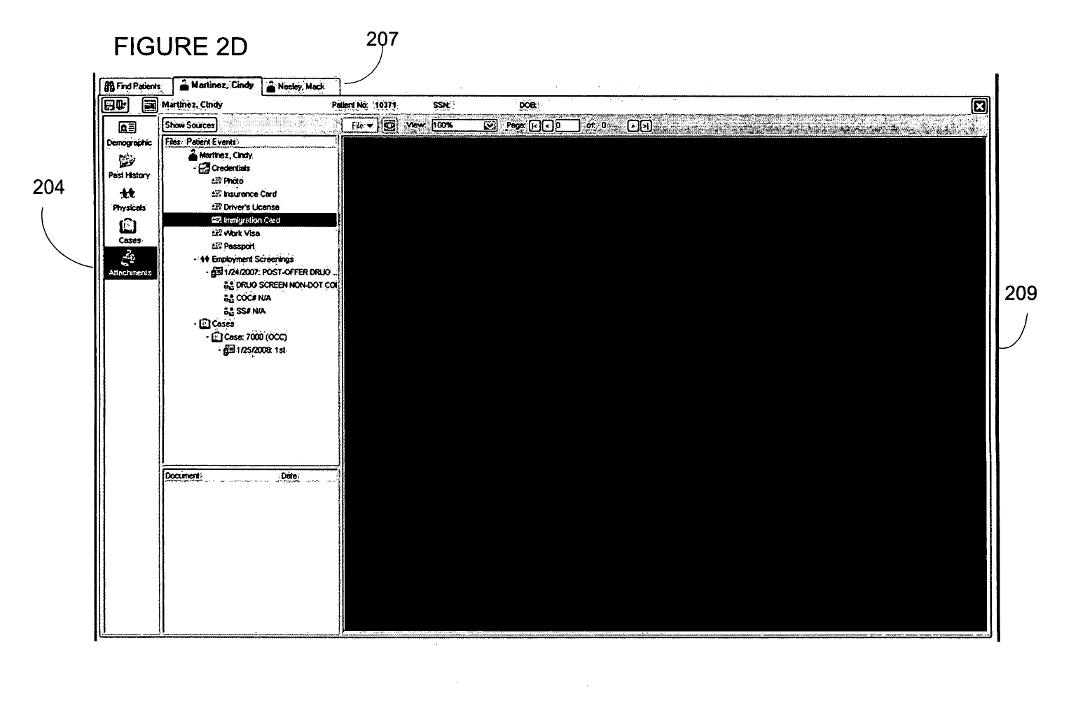

FIG. 2 shows a graphical user interface that is presented to the user upon selection of the “Patients” category from 112c. Upon selection of 112c from the category selection 112 the relevant category is loaded into 114. In this example, 112c represents “Patients,” which FIG. 2 in this example represents. As such upon selection of “Patients” at 112c, the user is presented with an interface relating to subjects within the workflow.

The user is first presented with a search interface that allows for the location of a subject within the system database. This search interface allows for a system user to enter the name or identifying number of a subject and locate that record for use by the user. Upon selection of a subject a further interface is presented to the user, shown in FIG. 2. This interface comprises all information relating to the specific subject in a single, nested interface. The top of this subject detail interface comprises a set of rectangular tabs that allow for switching between subject details at 207. Directly beneath these tabs is basic information identifying the subject, in this example the patient's name, number and date of birth is shown. In this embodiment, the left hand side of the interface comprises a vertical screen region with graphical representations of subject sub-categories, shown at 204. In this example, a user can select “Demographics” to activate demographic-related subject information and interface, “past history” will provide a history screen, “Physicals” activates the interface relating to physical examination and/or drug screening appointments for the subject within a hospital or clinic, “Cases” activates the interface relating to specific medical cases for the subject within a hospital or clinic, and “Attachments” allows a user to place attachments in the subject file. To the right of this sub-category selection region is screen region 209 which contains the interface for the sub-categories upon their selection. For example, if a user were to select “Demographics” from the sub-category selection interface, screen region 209 may contain the demographics sub-category interface (shown in FIG. 2C), whereas if a user were to select “Physicals” from the sub-category selection interface, screen region 209 may contain the physicals sub-category interface (shown in FIG. 2A). The sub-categories for the subject will vary depending on the workflow environment and the type of subject, and are specified as above in an example embodiment of a patient within a hospital or clinic.

FIG. 2A shows a sub-category interface loaded into screen region 209. FIG. 2A relates to the example sub-category “Physicals” as shown in sub-category selection region 204. In this example, to the right of sub-category selection screen region 204 is physicals detail region 205, which comprises a listing of workflow entries under the sub-category selected. To the right of this listing region is a set of screen regions comprising details of the subject's entry and exit within the workflow, shown at 201, 202 and 203. Beneath these screen regions is a set of rectangular tabs that allows access to further details stored in the subject file at 206. Selection of one of these tabs presents the corresponding interface beneath the tabs in a rectangular screen region at 208.

The population of screen regions which relate to the details of subject entry within the workflow is determined by selection of an entry at 205. This allows for multiple entries into the workflow, all associated with the same subject, to be stored and accessed separately from each other by selection of the specific instance from screen region 205.

FIG. 2B shows a further sub-category interface loaded into screen region 209. FIG. 2B relates to the example sub-category “Cases” as shown in sub-category selection region 204. In this example, to the right of sub-category selection region 204 is the cases detail region, which comprises details of cases related to the selected subject. Within this sub-category interface is shown details of cases at 212, as well as a set of rectangular tabs that allows access to further details stored in the subject file at 206a. Selection of one of these tabs at 206a presents a further details interface at 208, which comprises further details related to the sub-category selected at 204.

FIG. 2C shows a further sub-category interface loaded into screen region 209. FIG. 2C relates to the example sub-category “Demographics.” To the right of sub-category selection region 204 is a simple form for the entry of subject information at 210. In this example embodiment where the subject is a patient, demographic information includes first and last names, an associated doctor, social security numbers and employer details. In other embodiments this information could be any data that identifies the subject in a desired manner.

Referring now to FIG. 2, a graphical user interface depicting the subject screen in accordance with one or more embodiments of the invention. The interface is arranged to permit access to the subject details in a single interface that extends to contain multiple subparts. In the example depicted here the graphical user interface is compartmentalized as described above into screen regions with each screen region being configured to provide and/or permit entry of further detail based on the higher-level selection made by the user. The category screen region (204) defines the content to be entered or provided in the sub-level interfaces at a high level.

The sub-levels for each category are organized to permit users access to the information about the category by navigating the sub-level interfaces rather than having to open multiple windows. Hence users are given at a glance information about details relevant to the category. In FIG. 2 for instance when the patient category is actively selected the sub-levels contain interface components that permit the user to find and select a patient. For each selected patient a sub-interface is initiated that provides further detail about the patient. The system makes use of a single nested sub-interface for each patient when the patient category interface is chosen. Thus details about multiple patients can be traversed without leaving the category interface that relates to patient information. The same concept of having sub-interfaces within a category where the sub-interfaces are navigable through tabs or some other extensible interface element and relevant to the category is also possible to implement in contexts other than patients. Hence one or more embodiments of the invention are generalized to the concept of rendering a category screen region and then providing sub-interface elements within that screen region where details about the subject of the category are entered or searched through the sub-interface. While the example depicted in FIG. 2 is illustrated in the context of a patient any repository of information about a subject or item benefit from making use of an interface restricted to a category where detail about items within the category is presented in sub-interfaces and a new sub-interface within the category interface is spawned when further detail or information is needed about the subject or items within the category.

In the exemplary workflow described herein the system is centered around subjects such as patients in a medical clinic. Once a patient is opened in the sub-interface and assigned a sign-in time, entry into the workflow is initiated. Referring to FIGS. 2A and 2B, which represent the specific situation for which the subject is entering the workflow, the screen region for completion of the entry point details is presented at 201, shown in the method at point 408 in FIG. 4. In FIGS. 2A and 2B, element 201 is shown as an example used to obtain a sign-in time for the patient set by the end user, however it could represent any time stamp associated with the entry point. The “drag and drop” nature of the main interface shown in FIG. 1 is generally disabled for any person in the entry point section of 103 until the subject entry point details screen is completed and saved. When saved the subject in question is moved by the workflow system to the next section point in 104, described in the method at points 409 to 410. In the example depicted in FIG. 1 the interface is shown as a patient designated as “waiting to be seen.” The waiting status is indicated on the screen for reference. Waiting to be seen is indicative of any point where the subject is in limbo until moved to a point at 109, which in this example represents clinic rooms in a hospital or other clinical type environment where patients are treated. The status point at 109 could be any position in a workflow where the items represent actions undertaken by a professional, or a location where a professional conducts his or her work, for further example a lawyer's office, or a table in a restaurant. Once the waiting status is given the subject from screen region 104 can be moved into screen region 109. As stated above this region represents a point in the workflow where actions on the subject are being taken. The system automatically records the time of movement from limbo state 104 to the actioning state 109. This movement of persons around the workflow is represented in the method illustrated in FIG. 4 at point 412, where a subject is associated with an actioning state.

In FIG. 1, screen region 108 represents a set of professionals available for the date and corresponding list specified in screen regions 107 and 102, in this example called ‘providers.’ Available professionals are determined by a scheduling process which will be detailed later. Upon a subject from screen region 104 being moved to actioning region 109, a provider, in the example given a list of doctors, nurses and other health professionals, can be moved alongside the subject's name in region 109, occurring at method action 413 thus indicating that a provider is currently working on, or with, the subject in a particular area, in this example a doctor working with a patient in a clinic room. The act of moving a provider from 108 to 109 creates another timestamp, being the time that a professional commenced work on a specific subject. It could be seen that screen region 109 in the example given is the driving force behind the rest of the interface's function for day to day running of workflow operations. As a subject waiting at 104 must wait until a section of 109 becomes available, shown at FIG. 4 method step 411, so must professionals be available to render their services in the same region.

Multiple providers may be associated with a subject, as shown at method 414 through 416. The provider moves between subjects in the actioning region at 109, and can also move back to providers region 108. Once one provider has completed an action, said provider can be moved out of the actioning region and a new provider can be further associated with the subject. This allows for a multiple number of providers to operate on one subject at multiple times.

A subject between regions 104, 105 and 109, and professionals between regions 108 and 109, are not locked in the same way that a subject waiting for entry completion at region 103 cannot be moved until it is completed. As such subjects can move between the waiting regions 104 and 105, as well as actioning status in 109 infinitely depending on their status in a dynamic workflow. Each movement within the workflow is timestamped by the system; as such this could provide for reporting on time taken between actions for the purposes of efficiency monitoring, or simply to provide a report of all movement within the workflow for a particular subject. It would be easily apparent to all that the timestamping of actions within a workflow as they happen could be highly beneficial to anyone interested in creating time based workflow reports. In the context of the examples shown, this could also be of benefit to the subjects to provide accurate and updated waiting times based on trends as reported and analyzed by the system.

FIG. 1 also shows workflow exit points at screen region 105 and 106. In this example screen region 105 represents a patient waiting to sign out, although this could be any ‘limbo’ point that a subject is in before exiting the workflow. Upon the completion of all provider steps shown at method 414-416, the state of the subject is changed to waiting at 417, and upon user input from an operator indicated that waiting has completed at 418, the state of the subject is changed to signing out at 419. Upon the movement of said subject to the exit point 106 at method step 419, the end user is presented with the same interface seen at the entry point in FIG. 2a or 2b. An exit time is manually set by the end user at 202 or 202b and saved. This indicates that signing out has been completed at method step 420 and moves the subject out of the main body of the workflow, shown at method step 421. Any point of exit can be used; such as a document's completion, a customer paying for their purchase, among a multitude of other options.

In this embodiment of the application the subject, at a time subsequent to exiting the workflow, goes through user input at 206, where in this example results for laboratory tests or other instructions can be provided. This is shown at method step 422. Any such ‘case closing’ information could be entered here, such as successful court judgments, insurance policy issuance, all of which are determined by the embodiment being employed. This optional step allows a subject to be entered into a billing review queue, where a user qualified to bill subjects for professional services would create and issue relevant invoices or forms.

In one embodiment of the invention this ‘overview’ interface of workflow operations can be operated by multiple persons at once. The interface can connect to, and garner data from, a database located on a shared server. The system refreshes data at each passing of a time interval. This interval can be a chosen arbitrary interval, or system refresh could occur in real time upon data update. The refresh interval can be set according to the needs of the embodiment. In this embodiment, the arbitrary time interval is set at every few seconds, so that as one person makes an update to the position of a subject in the workflow, it is reflected on all other stations connected to the same database within a few seconds. This provides for actions, and movement of subjects and actions within the workflow to be conducted by a multitude of users. In the example embodiment shown in the figures, a receptionist in a clinic could sign a patient in upon arrival at the front desk, moving the patient to the waiting to be seen status section, from where a nurse about to conduct triage could move them from the waiting to be seen status to an actioning status, representative of an examination room, and then back to the waiting to be seen status until a doctor collects them and conducts the same process. When a patient is ready to leave, the doctor moves the patient to a waiting to sign out status, and subsequently signed out and set for billing by the receptionist, or other professional. It will be readily apparent however that this system could function in many ways, including, but certainly not limited to, a bank with multiple customers being served, a lawyer's office and others.

This overview screen shown in FIG. 1 can be used in many different embodiments. As described that the overview can be operated by a multitude of users, a multitude of devices could also be used by a user to view and interact with the interfaces provided. For example in a hospital a large touch screen device wall mounted could provide an interactive way to move patients from room to room providing the same ‘ward layout’ that most hospitals traditionally manage with a whiteboard and erasable marker. A dynamic, interactive screen would eliminate the need for manually writing, erasing and re-entering information in this manner. A Personal Digital Assistant (or PDA) could also be used and carried by users interacting with the interface. It will be apparent that any device or multitude of devices could be used and configured to operate with the embodiment in a consistent manner.

The overview interface can also be used by users to provide a snapshot that could be recorded for reporting purposes. In the context of the examples provided this would involve taking a ‘snapshot’ of the overview at a specific date and time, which can then be compared to others.

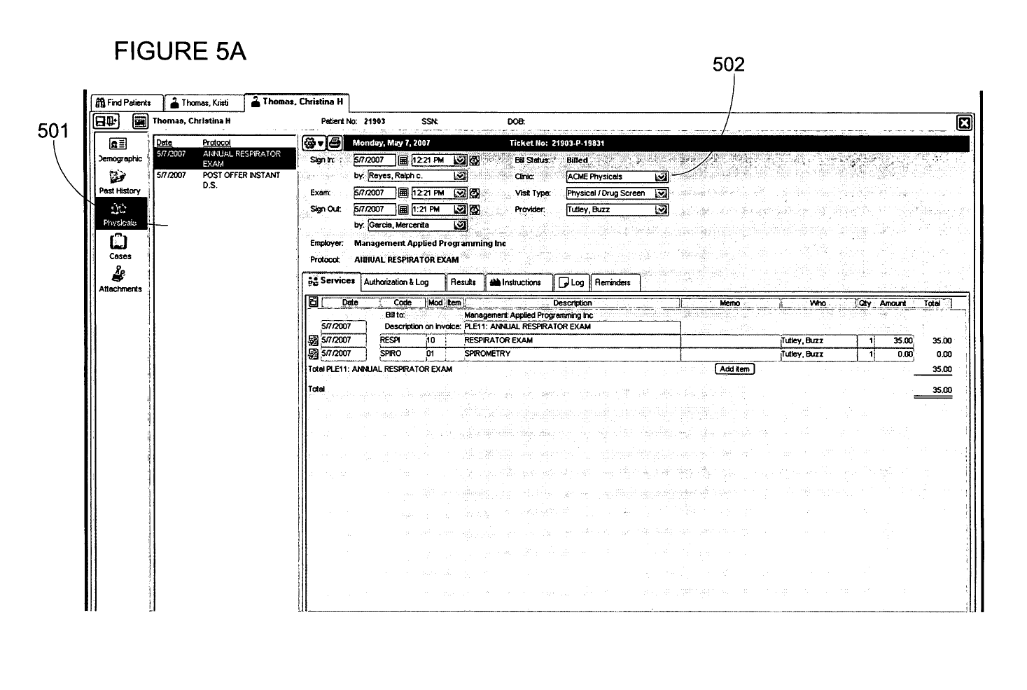

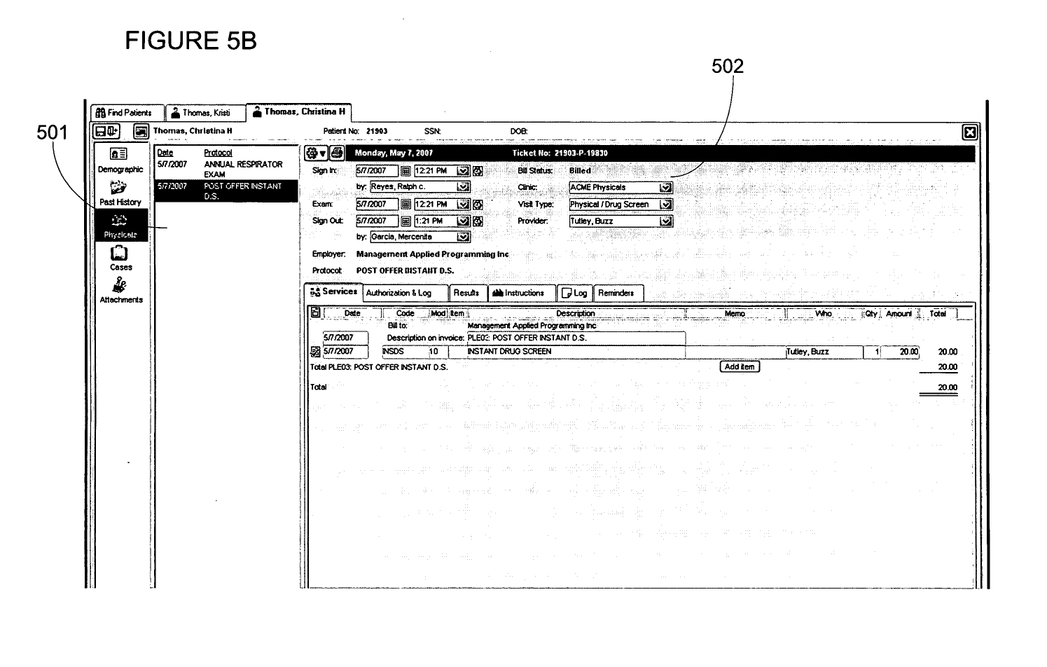

As described, a subject is created as a record within the database before entering the workflow system itself. The subject is then scheduled for entry and progresses naturally throughout the workflow. Upon exiting the workflow any subsequent actions are completed and the matter is considered closed. However the same subject can enter and move through the workflow several times for different required actions. This can be demonstrated in FIGS. 5A and 5B, which is a further embodiment of FIG. 2A. This embodiment of the figure shows a subject detail screen, and the selection of the “Physicals” button presents a subject detail screen giving details of physical examinations previously performed. In this example, two are listed at 501 and selecting each date of examination changes the details shown in the further details region at 502, as is demonstrated in the difference between FIGS. 5A and 5B. This allows for a subject to enter the workflow multiple times and to have each entry into the workflow recorded as separate events, including the ability to have several purposes for each. While each entry into the workflow is recorded as a separate event, the listing of events shown in FIGS. 5A and 5B allows for traversal of multiple events where each event is associated with a single subject, without requiring the user to search for events associated with a common subject separately. Also, navigation of events associated with a common subject is centralized within the subject interface. In this embodiment, different physical examinations associated with the same patient can be traversed from the same interface.

A further embodiment of this case and event traversal can be shown in FIG. 2B. FIG. 2B shows in this example a patient having multiple case histories shown in a listing screen region at 211, which shows a unique identifier associated with a case. Activation of this screen region presents a further detailed listing screen region 212 which comprises a listing of specific case that allows for appropriate selection by a user. Upon user selection of a case from 212, the interface is loaded with details of the selected case. Selection of a different case from 212 alters the information displayed in the sub-category view 209, and all further information at 208. Any entry into the workflow related to both the subject and the specific case can then be traversed in a manner similar to that described above in the “physicals” example, where each entrance and exit into the workflow is listed at 213 and selection of an entry provides further details. It will be apparent that this system allows for a hierarchy of detail to be implemented in views and interfaces that are nested within each other to provide for a logical separation and clustering of information. In this example, such a hierarchy consists of a patient having associated cases, and each case having separate visits recorded against the case, although the type and specifics of information stored in this hierarchical format can vary depending on what is appropriate for the locational workflow being used.

At any stage of the workflow the user can double click on the subject to open up the subject details screen in FIG. 2. This presents the end user with a multitude of options relating to the subject's specific requirements. In the examples currently provided the subject is a fictitious patient by the name of Rosalie Navarro who is undergoing a physical exam. FIG. 2 in this example represents the physical exam options. The side bar at 204 shows different sections of a subject's detailed record. In this example, the Demographic button opens up a section for patient information to be filled (FIG. 2C), the Physicals button shows details relating to physical examinations for a patient (FIG. 2A), the cases button shows details related to injuries and illness for a patient (FIG. 2B) and Attachments provides a container for the inclusion of text and image documents into a patient chart, for example a health insurance card scan (FIG. 2D). These options could be any details that a system would need to gather relating to subjects in a workflow, such as customer details, document information, or any other types of information used. It will be readily apparent that these sections could be separated in many ways, and while the separations shown are used in context of the example, any category of separation of subject details can be utilized depending on the embodiment implemented.

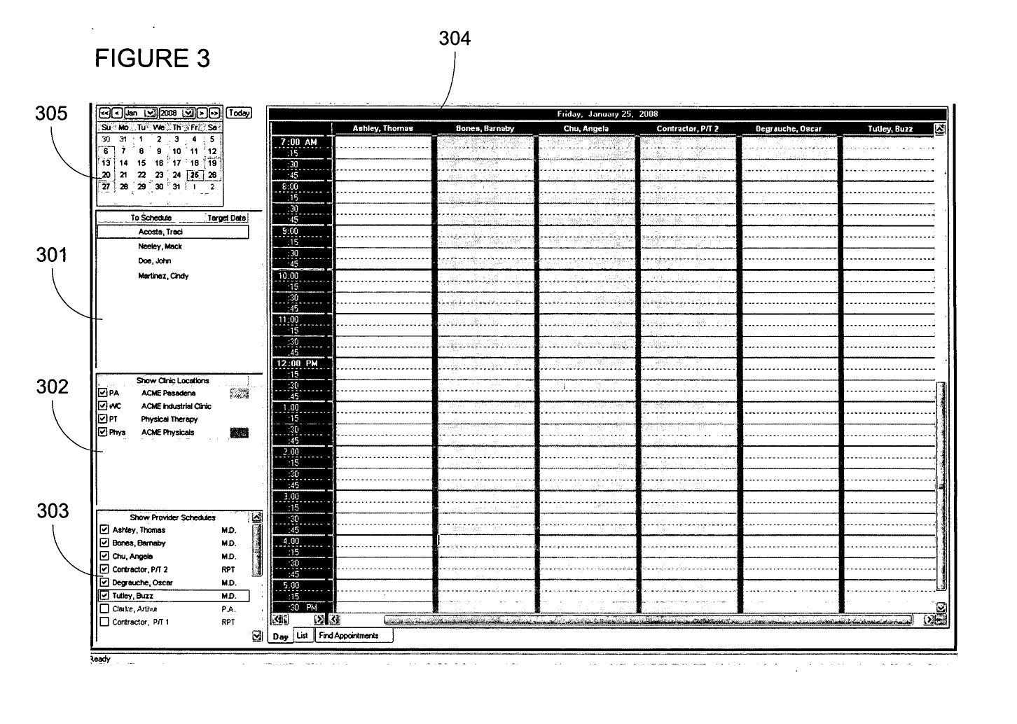

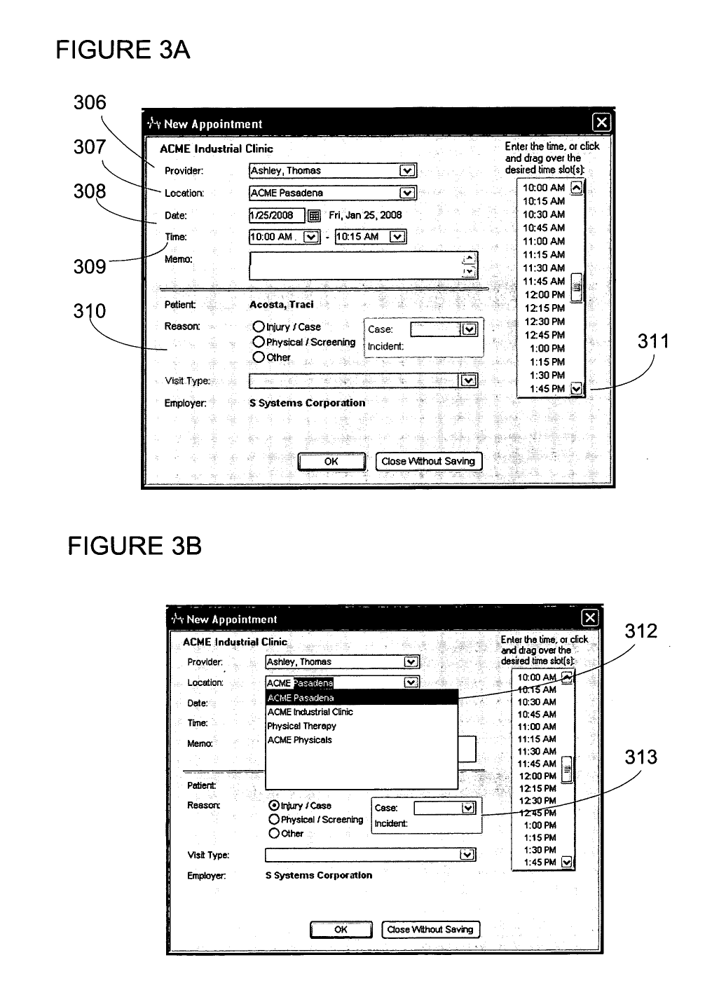

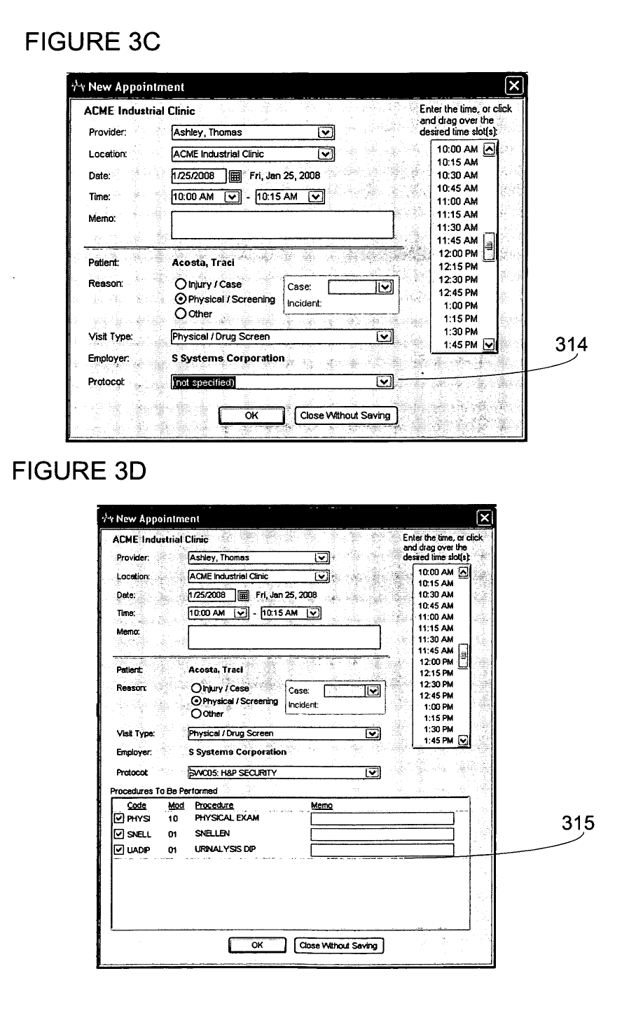

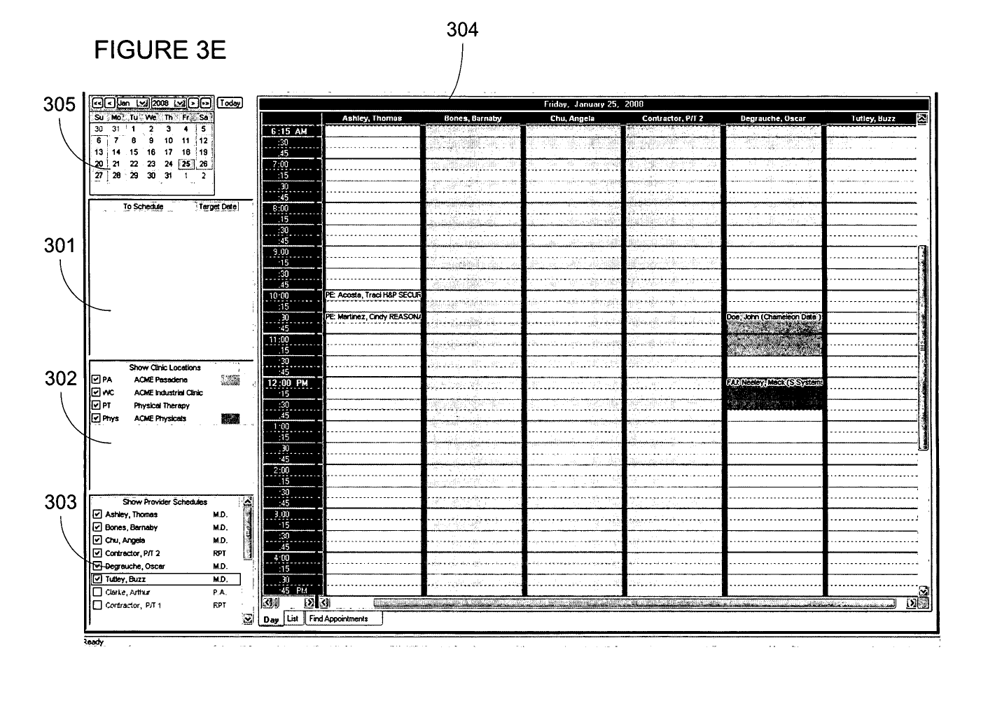

FIG. 3 comprises a set of screen regions relating to a scheduling interface. On the left hand side of this interface are vertically arranged rectangular screen regions, to the right of these screen regions is a large screen region 304 arranged in the form of a table which in this embodiment comprises personal schedules as columns, with the time of day functioning as rows. In other embodiments the columns and rows may represent any scheduling needs required by the workflow. The top most screen region at 305 comprises screen regions functioning as a calendar, where selection of a particular date from the calendar changes the view in 304 to reflect the desired date. Beneath this date selection screen region is a screen region at 301 containing subjects for scheduling on the interface 304 in the form of a list, where selection and dragging of subjects from 301 to 304 begins the scheduling process. Beneath that screen region are screen regions comprising lists that upon activation of an item within the list alters the view at 304 to correspond with the views desired by the system operator.

The top of the user interface contains a button used to enter a schedule next to the title of the subject at 207. FIG. 3 shows a scheduling interface. Using the scheduling button shown on FIG. 2 places the subject record title into screen region 301 which can then be moved in the same fashion as subject items in FIG. 1, through drag and drop onto a provider's schedule. The providers shown in schedule screen region 304 are selected by a check box shown at 303. Once the end user has drag-and-dropped the subject to be scheduled into the desired column, a scheduling interface is presented to the user, shown in FIG. 3A. This scheduling interface comprises a set of screen regions shown at elements 306, 307, 308, 309, 310, and 311, for the selection of details relating to the appointment to be scheduled on the scheduling interface, where the detail options available directly relate to the type of appointment being scheduled. It is apparent that in this example certain feature are automatically added, such as the example selected from the drag and drop of the subject, a location for the scheduling, date and time and subject information. In this example a reason section is provided for a patient case to be entered at 310. Further in this example selection of a reason, being an injury or physical exam presents several different sets of input as shown in FIG. 3B, at elements 312 and 313, and FIG. 3C, where further different options are shown at 314. It will be readily apparent however that this could be a multitude of selected options that are germane to the type of subjects within a workflow being tracked or scheduled.

In the example provided, shown in FIG. 3D, the selection of an option at element 314 from FIG. 3C allows for the selection of actions that are preset in the database and shown at 315. These so called protocol group policies are sets of actions that would be common to a specific situation, and these protocol groups policies are associated with a higher protocol group with which the subject is directly associated with. This, in any application, allows for the quick and easy selection of actions needing professional services where the actions are performed routinely in sequence.

There are many reasons why subjects could be associated with what we will call protocol groups. The ability to categorize subjects by criteria allows for easy decisions to be made by the system or user, and allowing actions that are relevant to the subject to be presented. In the examples shown of a clinic, employers are shown to be these protocol groups. In the context of this method, an employer could contract with the hospital clinic to provide services to employees. As such subjects upon entry are associated with their employer, that employer becomes their protocol group.

Each employer would have separate screening or workers injury requirements. For example, an employee in a metal working factory might require three separate drug and alcohol tests on a regular basis. This system can be programmed to create a protocol, for example, named “Drug Tests: Regular” that contains a list of the three tests to be performed. Upon scheduling of a subject as shown in FIG. 3 associated with the metal working factory the user can then select this preset protocol from a list and the system automatically selects the actions necessary to be performed at scheduling and present this information to the users. This would be most applicable in an occupational health context.

Another option for protocol groups would be in a lawyer's office, where the subject denotes a client engaged in a family law case. In such an example the protocols would represent different cases, such as divorce, adoption, wills and testaments etc., and the procedures to follow would include items such as depositions, court appearances, and so on. It will be evident to the reader that this classification of tasks with assigned options and automatic policies allows for consistent application of professional services within a workflow while at the same time streamlining the need for extensive replication of data from subject to subject.

Protocol groups are obtained and defined at step 401 in the method. In the examples provided at FIG. 3, the protocol group is the employer with which the subject is associated. Each employer in the example has a set of procedures depending on whether the subject is being scheduled for an injury or for a screening process. This would allow a user to select a set of procedures to perform automatically based on the situation, as well as obtain employer specific instructions. If Patient enters the clinic for a pre-employment drug screen for Employer, then the user can select the relevant protocol group's set policies from the drop down box at 314, which then presents a set of procedures to be performed at method step 404. These procedures are defined and associated with a protocol group by a user at step 402 prior to entry of a subject into the database. Further to this, subject detail is obtained at 403.

Upon the scheduling of a subject and the selection of a procedure the system is capable of automatically retrieving the information set in Method step 402 at method step 404.

Upon creation of a subject in the database, said subject is assigned a protocol group which determines the sets of protocol group procedures to associate as well as billing procedures should they apply. In the example figures shown this is an employer, though this protocol group could be anything, such as selecting the type of customer, the type of document in the workflow or other iterations that could be contemplated.

As shown in FIG. 3E, upon the completed scheduling of subjects they appear in provider schedules, colored to reflect a key shown at 302. This scheduled list is used to populate the schedule at 101, where the population occurs in the method after scheduling at 406.

A user can navigate through the system using a set of graphical buttons located near the very top of the screen. These buttons change the user interfaces presented in the lower parts of the screen, and the color of the button can change to indicate the current user interface being utilized by the user, while the top buttons are persistent in that they are shown throughout all interfaces and present the user with a single point to access all information contained in the system. In the example provided, these buttons indicate whether the user is viewing patient details, clinic overviews, schedules, billing and accounts receivable, or other screens pertinent to the operation of a medical clinic. Any screen view can be represented and accessed via these buttons. It is also apparent that any method of accessing and using the system can be utilized, including but not limited to a set of menu options or text based selections, command line instructions or others.

This same navigational structure of buttons is present throughout the embodiment shown in this invention. Buttons on the left side of the subject details screen control shown on FIGS. 2 and 5 which details of the subject are being shown. While these graphical buttons are only present under the section when selected by the top navigation panel, they remain persistent in the same way while navigating through the data presented in subject details. The reader will also note that in this embodiment the interface operates in an embedded manner, similar to Multi-Document Interfaces, where the selection of a top level item, such as subject details, changes the screen below to that section, and selection of subsections with the left panel changes the bulk section of the interface, and further selection of sections as shown in 206 changes that specific section to provide details. This is only one possible implementation of the interface and it will be apparent that any combination of graphics or text, as well as the layout of the interface itself can be any embodiment depending on the implementation used. Also the embedded nature of this interface could be modified so as to present all information in separate screens with the ability to be independently manipulated by the user.

It will be readily apparent that the inclusion of ‘drag and drop’ technology, as well as the emphasis on graphical representations of subjects and positions within a workflow is intended to provide an easily used interface for monitoring and manipulating a workflow system. The interface is also designed to minimize the amount of training required for a user to utilize the system.

While the invention herein disclosed has been described by means of specific embodiments and applications thereof, numerous modifications and variations could be made thereto by those skilled in the art without departing from the scope of the invention set forth in the claims.

What is claimed is:

1. A method for integrating locational awareness into a subject oriented workflow in a professional services environment comprising:
presenting an intake interface to intake personnel on receipt of an indication a subject desires services rendered in a professional services environment;
obtaining identifying information associated with said subject through said intake interface for processing in association with an employer of said subject;
obtaining protocol group details that comprise at least one action requiring professional services;
associating said subject with said at least one action based on said protocol group details and storing said at least one action in a computer system for presentation to a professional rendering said professional services when services are to be rendered;
presenting a graphical user interface comprising a list of at least one graphical representation of subjects having associated actions scheduled for professional services within a defined timeframe;
presenting a graphical user interface component comprising a list of at least one graphical representation of professionals being able to render professional services to subjects with associated actions;
indicating an intake status of said subject by moving said at least one graphical representation to a screen region that associates said intake status with said subject;
obtaining a sign-in time through a subject interface to associate with a subject;
associating said subject to a waiting status based on said sign-in time;
indicating a status of said subject by moving (drag and drop) said at least one graphical representation of said subject to a screen region defined to associate an occurring action or status change with said subject;
indicating said subject has an assigned professional by moving (drag and drop) said graphical representation of said professional to a screen region defined to associate an occurring action or status change with said subject and to associate said professional with said subject in said screen region;
indicating a status of said subject by moving (drag and drop) said at least one graphical representation of said subject to a screen region defined to associate a sign-out status with said subject;
presenting a graphical user interface comprising a set of at least one graphical representation of said subject with associated actions to set sign-out status and to provide details of services rendered into graphical user interface;
indicating that said subject and actions performed may be reviewed by moving said subject details to review database.
